(19) United States
(12) Patent Application Publication
(10) Pub. No.: US 2008/0117296 A1
(43) Pub. Date: May 22, 2008

(54) Master-slave automated video-based surveillance system

(75) Inventors: Geoffrey Egnal, Washington, DC (US); Andrew Chosak, Arlington, VA (US); Niels Haering, Reston, VA (US); Alan J. Lipton, Herndon, VA (US); Peter L. Venetianer, McLean, VA (US); Weihong Yin, Herndon, VA (US); Zhong Zhang, Herndon, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 12/010,269

(22) Filed: Jan. 23, 2008

Related U.S. Application Data
(62) Division of application No. 10/740,511, filed on Dec. 22, 2003.
(60) Provisional application No. 60/448,472, filed on Feb. 21, 2003.

(51) Int. Cl. H04N 7/18

(52) U.S. Cl. 348/143; 348/E07.085

(57) ABSTRACT

A video surveillance system comprises a first sensing unit; a second sensing unit; and a communication medium connecting the first sensing unit and the second sensing unit. The first sensing unit provides information about a position of a target to the second sensing unit via the communication medium, and the second sensing unit uses the position information to locate the target.

This application claims priority to U.S. Provisional Patent Application No. 60/448,472, filed Feb. 21, 2003.

### FIELD OF THE INVENTION

The present invention is related to methods and systems for performing video-based surveillance. More specifically, the invention is related to such systems involving multiple interacting sensing devices (e.g., video cameras).

### BACKGROUND OF THE INVENTION

Many businesses and other facilities, such as banks, stores, airports, etc., make use of security systems. Among such systems are video-based systems, in which a sensing device, like a video camera, obtains and records images within its sensory field. For example, a video camera will provide a video record of whatever is within the field-of-view of its lens. Such video images may be monitored by a human operator and/or reviewed later by a human operator. Recent progress has allowed such video images to be monitored also by an automated system, improving detection rates and saving human labor.

In many situations, for example, if a robbery is in progress, it would be desirable to detect a target (e.g., a robber) and obtain a high-resolution video or picture of the target. However, a typical purchaser of a security system may be driven by cost considerations to install as few sensing devices as possible. In typical systems, therefore, one or a few wide-angle cameras are used, in order to obtain the broadest coverage at the lowest cost. A system may further include a pan-tilt-zoom (PTZ) sensing device, as well, in order to obtain a high-resolution image of a target. The problem, however, is that such systems require a human operator to recognize the target and to train the PTZ sensing device on the recognized target, a process which may be inaccurate and is often too slow to catch the target.

### SUMMARY OF THE INVENTION

The present invention is directed to a system and method for automating the above-described process. That is, the present invention requires relatively few cameras (or other sensing devices), and it uses the wide-angle camera(s) to spot unusual activity, and then uses a PTZ camera to zoom in and record recognition and location information. This is done without any human intervention.

In a first embodiment of the invention, a video surveillance system comprises a first sensing unit; at least one second sensing unit; and a communication medium connecting the first sensing unit and the second sensing unit. The first sensing unit provides information about a position of an interesting target to the second sensing unit via the communication medium, and the second sensing unit uses the position information to locate the target.

A second embodiment of the invention comprises a method of operating a video surveillance system, the video surveillance system including at least two sensing units, the method comprising the steps of using a first sensing unit to detect the presence of an interesting target; sending position information about the target from the first sensing unit to at least one second sensing unit; and training at least one second sensing unit on the target, based on the position information, to obtain a higher resolution image of the target than one obtained by the first sensing unit.

In a third embodiment of the invention, a video surveillance system comprises a first sensing unit; at least one second sensing unit; and a communication medium connecting the first sensing unit and the second sensing unit. The first sensing unit provides information about a position of an interesting target to the second sensing unit via the communication medium, and the second sensing unit uses the position information to locate the target. Further, the second sensing unit has an ability to actively track the target of interest beyond the field of view of the first sensing unit.

A fourth embodiment of the invention comprises a method of operating a video surveillance system, the video surveillance system including at least two sensing units, the method comprising the steps of using a first sensing unit to detect the presence of an interesting target; sending position information about the target from the first sensing unit to at least one second sensing unit; and training at least one second sensing unit on the target, based on the position information, to obtain a higher resolution image of the target than one obtained by the first sensing unit. The method then uses the second sensing unit to actively follow the interesting target beyond the field of view of the first sensing unit.

Further embodiments of the invention may include security systems and methods, as discussed above and in the subsequent discussion.

Further embodiments of the invention may include systems and methods of monitoring scientific experiments. For example, inventive systems and methods may be used to focus in on certain behaviors of subjects of experiments.

Further embodiments of the invention may include systems and methods useful in monitoring and recording sporting events. For example, such systems and methods may be useful in detecting certain behaviors of participants in sporting events (e.g., penalty-related actions in football or soccer games).

Yet further embodiments of the invention may be useful in gathering marketing information. For example, using the invention, one may be able to monitor the behaviors of customers (e.g., detecting interest in products by detecting what products they reach for).

The methods of the second and fourth embodiments may be implemented as software on a computer-readable medium. Furthermore, the invention may be embodied in the form of a computer system running such software.

### DEFINITIONS

The following definitions are applicable throughout this disclosure, including in the above.

A “video” refers to motion pictures represented in analog and/or digital form. Examples of video include: television, movies, image sequences from a video camera or other observer, and computer-generated image sequences.

A “frame” refers to a particular image or other discrete unit within a video.

An “object” refers to an item of interest in a video. Examples of an object include: a person, a vehicle, an animal, and a physical subject.

A “target” refers to the computer's model of an object. The target is derived from the image processing, and there is a one-to-one correspondence between targets and objects.

“Pan, tilt and zoom” refers to robotic motions that a sensor unit may perform. Panning is the action of a sensor rotating sideward about its central axis. Tilting is the action of a sensor rotating upward and downward about its central axis. Zooming is the action of a camera lens increasing the magnification, whether by physically changing the optics of the lens, or by digitally enlarging a portion of the image.

A “best shot” is the optimal frame of a target for recognition purposes, by human or machine. The “best shot” may be different for computer-based recognition systems and the human visual system.

An “activity” refers to one or more actions and/or one or more composites of actions of one or more objects. Examples of an activity include: entering; exiting; stopping; moving; raising; lowering; growing; and shrinking.

A “location” refers to a space where an activity may occur. A location can be, for example, scene-based or image-based. Examples of a scene-based location include: a public space; a store; a retail space; an office; a warehouse; a hotel room; a hotel lobby; a lobby of a building; a casino; a bus station; a train station; an airport; a port; a bus; a train; an airplane; and a ship. Examples of an image-based location include: a video image; a line in a video image; an area in a video image; a rectangular section of a video image; and a polygonal section of a video image.

An “event” refers to one or more objects engaged in an activity. The event may be referenced with respect to a location and/or a time.

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.

A “sensing device” refers to any apparatus for obtaining visual information. Examples include: color and monochrome cameras, video cameras, closed-circuit television (CCTV) cameras, charge-coupled device (CCD) sensors, analog and digital cameras, PC cameras, web cameras, and infra-red imaging devices. If not more specifically described, a “camera” refers to any sensing device.

A “blob” refers generally to any object in an image (usually, in the context of video). Examples of blobs include moving objects (e.g., people and vehicles) and stationary objects (e.g., furniture and consumer goods on shelves in a store).

### BRIEF DESCRIPTION OF THE DRAWINGS

Specific embodiments of the invention will now be described in further detail in conjunction with the attached drawings, in which:

FIG. 1 depicts a conceptual embodiment of the invention, showing how master and slave cameras may cooperate to obtain a high-resolution image of a target;

FIG. 2 depicts a conceptual block diagram of a master unit according to an embodiment of the invention;

FIG. 3 depicts a conceptual block diagram of a slave unit according to an embodiment of the invention;

FIG. 4 depicts a flowchart of processing operations according to an embodiment of the invention;

FIG. 5 depicts a flowchart of processing operations in an active slave unit according to an embodiment of the invention; and

FIG. 6 depicts a flowchart of processing operations of a vision module according to an embodiment of the invention.

### DETAILED DESCRIPTION OF EMBODIMENTS OF THE INVENTION

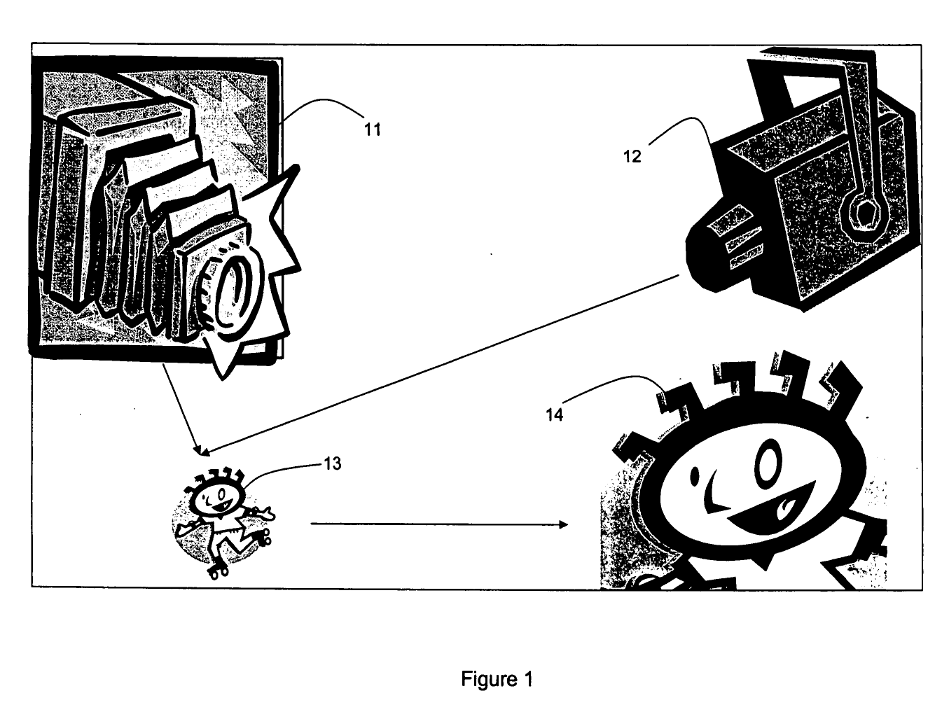

FIG. 1 depicts a first embodiment of the invention. The system of FIG. 1 uses one camera 11, called the master, to provide an overall picture of the scene 13, and another camera 12, called the slave, to provide high-resolution pictures of targets of interest 14. While FIG. 1 shows only one master and one slave, there may be multiple masters 11, the master 11 may utilize multiple units (e.g., multiple cameras), and/or there may be multiple slaves 12.

The master 12 may comprise, for example, a digital video camera attached to a computer. The computer runs software that performs a number of tasks, including segmenting moving objects from the background, combining foreground pixels into blobs, deciding when blobs split and merge to become targets, tracking targets, and responding to a watchstander (for example, by means of e-mail, alerts, or the like) if the targets engage in predetermined activities (e.g., entry into unauthorized areas). Examples of detectable actions include crossing a tripwire, appearing, disappearing, loitering, and removing or depositing an item.

Upon detecting a predetermined activity, the master 11 can also order a slave 12 to follow the target using a pan, tilt, and zoom (PTZ) camera. The slave 12 receives a stream of position data about targets from the master 11, filters it, and translates the stream into pan, tilt, and zoom signals for a robotic PTZ camera unit. The resulting system is one in which one camera detects threats, and the other robotic camera obtains high-resolution pictures of the threatening targets. Further details about the operation of the system will be discussed below.

The system can also be extended. For instance, one may add multiple slaves 12 to a given master 11. One may have multiple masters 11 commanding a single slave 12. Also, one may use different kinds of cameras for the master 11 or for the slave(s) 12. For example, a normal, perspective camera or an omni-camera may be used as cameras for the master 11. One could also use thermal, near-IR, color, black-and-white, fisheye, telephoto, zoom and other camera/lens combinations as the master 11 or slave 12 camera.

In various embodiments, the slave 12 may be completely passive, or it may perform some processing. In a completely passive embodiment, slave 12 can only receive position data and operate on that data. It can not generate any estimates about the target on its own. This means that once the target leaves the master's field of view, the slave stops following the target, even if the target is still in the slave's field of view.

In other embodiments, slave 12 may perform some processing/tracking functions. In a limiting case, slave 12 and master 11 are peer systems. Further details of these embodiments will be discussed below.

Calibration

Embodiments of the inventive system may employ a communication protocol for communicating position data between the master and slave. In the most general embodiment of the invention, the cameras may be placed arbitrarily, as long as their fields of view have at least a minimal overlap. A calibration process is then needed to communicate position data between master 11 and slave 12 using a common language. There are at least two possible calibration algorithms that may be used. The following two have been used in exemplary implementations of the system; however, the invention is not to be understood as being limited to using these two algorithms.

The first requires measured points in a global coordinate system (obtained using GPS, laser theodolite, tape measure, or any measuring device), and the locations of these measured points in each camera's image. Any calibration algorithm, for example, the well-known algorithms of Tsai and Faugeras (described in detail in, for example, Trucco and Verri's “Introductory Techniques for 3-D Computer Vision”, Prentice Hall 1998), may be used to calculate all required camera parameters based on the measured points. Note that while the discussion below refers to the use of the algorithms of Tsai and Faugeras, the invention is not limited to the use of their algorithms. The result of this calibration method is a projection matrix P. The master uses P and a site model to geo-locate the position of the target in 3D space. A site model is a 3D model of the scene viewed by the master sensor. The master draws a ray from the camera center through the target's bottom in the image to the site model at the point where the target's feet touch the site model.

The mathematics for the master to calculate the position works as follows. The master can extract the rotation and translation of its frame relative to the site model, or world, frame using the following formulae. The projection matrix is made up of intrinsic camera parameters A, a rotation matrix R, and a translation vector T, so that
P=A_{3×3}R_{3×3}[I_{3×3}−T_{3×1}],
and these values have to be found. We begin with
P=[M_{3×3}m_{3×3}],
where M and m are elements of the projection matrix returned by the calibration algorithms of Tsai and Faugeras. From P, we can deduce the camera center and rotation using the following formulae:
T=−M⁻¹m,
R=RQ(M),
where RQ is the QR decomposition (as described, for example, in “Numerical Recipes in C”), but reversed using simple mathematical adjustments as would be known by one of ordinary skill in the art. To trace a ray outwards from the master camera, we first need the ray source and the ray direction. The source is simply the camera center, T. The direction through a given pixel on the image plane can be described by

$$Direction = {M}^{- 1} ( \begin{matrix}{X}_{Pixel} \\ {Y}_{Pixel} \\ 1\end{matrix} ) ,$$

where X_{Pixel} and Y_{Pixel} are the image coordinates of the bottom of the target. To trace a ray outwards, one follows the direction from the source until a point on the site model is reached. For example, if the site model is a flat plane at Y_{World}=0 (where Y_{World} measures the vertical dimension in a world coordinate system), then the point of intersection would occur at

$$WorldPosition = T + Direction \times - \frac{{T}_{y}}{{Direction}_{y}} ,$$

where T_{y} and Direction_{y} are the vertical components of the T and Direction vectors, respectively. Of course, more complicated site models would involve intersecting rays with triangulated grids, a common procedure to one of ordinary skill in the art.

After the master sends the resulting X, Y, and Z position of the target to the slave, the slave first translates the data to its own coordinates using the formula:

$$( \begin{matrix}{X}_{Slave} \\ {Y}_{Slave} \\ {Z}_{Slave}\end{matrix} ) = R \times ( \begin{matrix}{X}_{World} \\ {Y}_{World} \\ {Z}_{World}\end{matrix} ) + T ,$$

where X_{Slave}, Y_{Slave}, Z_{Slave} measure points in a coordinate system where the slave pan-tilt center is the origin and the vertical axis corresponds to the vertical image axis. X_{World}, Y_{World}, Z_{World} measure points in an arbitrary world coordinate system. R and T are the rotation and translation values that take the world coordinate system to the slave reference frame. In this reference frame, the pan/tilt center is the origin and the frame is oriented so that Y measures the up/down axis and Z measures the distance from the camera center to the target along the axis at 0 tilt. The R and T values can be calculated using the same calibration procedure as was used for the master. The only difference between the two calibration procedures is that one must adjust the rotation matrix to account for the arbitrary position of the pan and tilt axes when the calibration image was taken by the slave to get to the zero pan and zero tilt positions. From here, the slave calculates the pan and tilt positions using the formulae:

$$Pan = {tan}^{- 1} ( \frac{{X}_{Slave}}{{Z}_{Slave}} )$$

$$Tilt = {tan}^{- 1} ( \frac{{Y}_{Slave}}{\sqrt{{X}_{Slave}^{2} + {Z}_{Slave}^{2}}} ) .$$

The zoom position is a lookup value based on the Euclidean distance to the target.

A second calibration algorithm, used in another exemplary implementation of the invention, would not require all this information. It would only require an operator to specify how the image location in the master camera 11 corresponds to pan, tilt and zoom settings. The calibration method would interpolate these values so that any image location in the master camera can translate to pan, tilt and zoom settings in the slave. In effect, the transformation is a homography from the master's image plane to the coordinate system of pan, tilt and zoom. The master would not send X, Y, and Z coordinates of the target in the world coordinate system, but would instead merely send X and Y image coordinates in the pixel coordinate system. To calculate the homography, one needs the correspondences between the master image and slave settings, typically given by a human operator. Any method to fit the homography H to these points inputted by the operator will work. An exemplary method uses a singular value decomposition (SVD) to find a linear approximation to the closest plane, and then uses non-linear optimization methods to refine the homography estimation. The slave can figure the resulting pan, tilt and zoom setting using the following formula:

$$( \begin{matrix}Pan \\ Tilt \\ Zoom\end{matrix} ) = H ( \begin{matrix}{X}_{MasterPixel} \\ {Y}_{MasterPixel} \\ 1\end{matrix} )$$

The advantage of the second system is time and convenience. In particular, people do not have to measure out global coordinates, so the second algorithm may be executed more quickly than the first algorithm. Moreover, the operator can calibrate two cameras from a chair in front of a camera in a control room, as opposed to walking outdoors without being able to view the sensory output. The disadvantages to the second algorithm, however, are generality, in that it assumes a planar surface, and only relates two particular cameras. If the surface is not planar, accuracy will be sacrificed. Also, the slave must store a homography for each master the slave may have to respond to.

### First Embodiment

### System Description

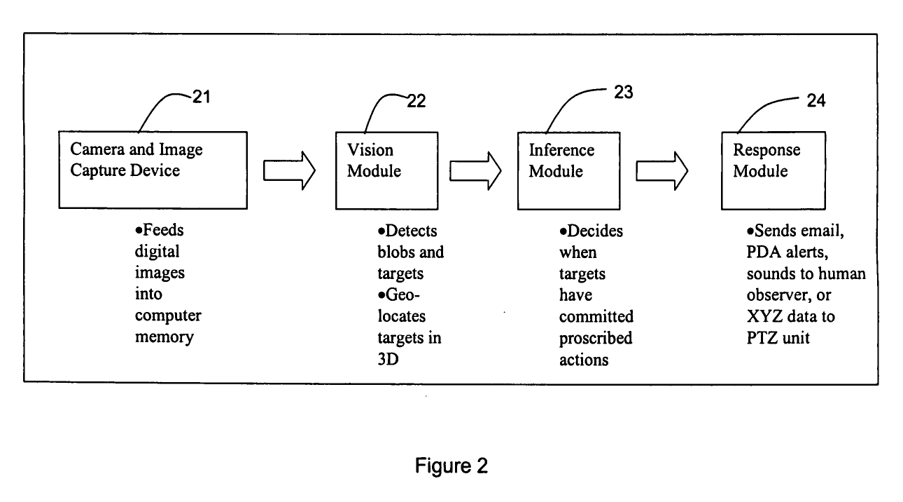

In a first, and most basic, embodiment, the slave 12 is entirely passive. This embodiment includes the master unit 11, which has all the necessary video processing algorithms for human activity recognition and threat detection. Additional, optional algorithms provide an ability to geo-locate targets in 3D space using a single camera and a special response that allows the master 11 to send the resulting position data to one or more slave units 12 via a communications system. These features of the master unit 11 are depicted in FIG. 2.

In particular, FIG. 2 shows the different modules comprising a master unit 11 according to a first embodiment of the invention. Master unit 11 includes a sensor device capable of obtaining an image; this is shown as “Camera and Image Capture Device” 21. Device 21 obtains (video) images and feeds them into memory (not shown).

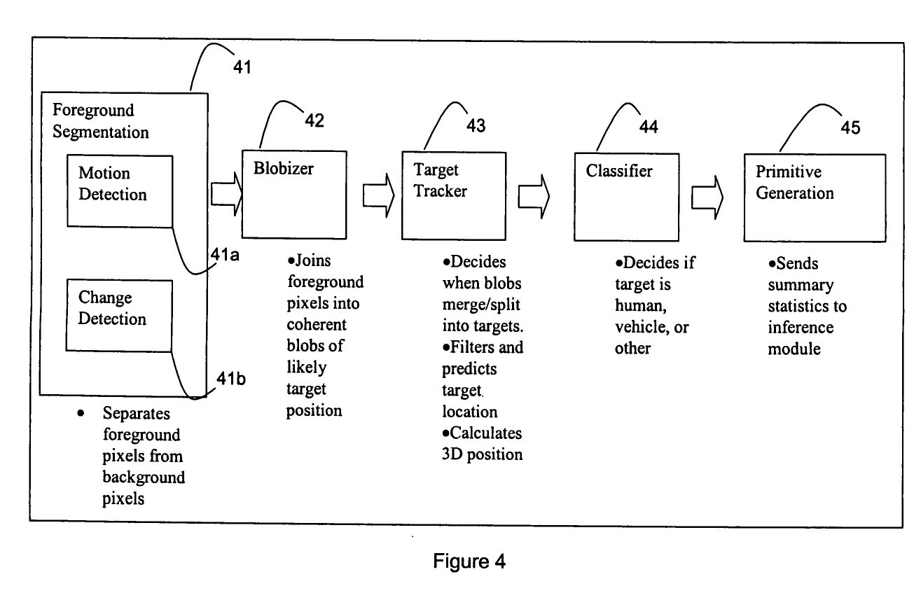

A vision module 22 processes the stored image data, performing, e.g., fundamental threat analysis and tracking. In particular, vision module 22 uses the image data to detect and classify targets. Optionally equipped with the necessary calibration information, this module has the ability to geo-locate these targets in 3D space. Further details of vision module 22 are shown in FIG. 4.

As shown in FIG. 4, vision module 22 includes a foreground segmentation module 41. Foreground segmentation module 41 determines pixels corresponding to background components of an image and foreground components of the image (where “foreground” pixels are, generally speaking, those associated with moving objects). Motion detection, module 41a, and change detection, module 41b, operate in parallel and may be performed in any order or concurrently. Any motion detection algorithm for detecting movement between frames at the pixel level can be used for block 41a. As an example, the three frame differencing technique, discussed in A. Lipton, H. Fujiyoshi, and R. S. Patil, “Moving Target Detection and Classification from Real-Time Video,” Proc. IEEE WACV '98, Princeton, N.J., 1998, pp. 8-14 (subsequently to be referred to as “Lipton, Fujiyoshi, and Patil”), can be used.

In block 41b, foreground pixels are detected via change. Any detection algorithm for detecting changes from a background model can be used for this block. An object is detected in this block if one or more pixels in a frame are deemed to be in the foreground of the frame because the pixels do not conform to a background model of the frame. As an example, a stochastic background modeling technique, such as the dynamically adaptive background subtraction techniques described in Lipton, Fujiyoshi, and Patil and in commonly-assigned, U.S. patent application Ser. No. 09/694,712, filed Oct. 24, 2000, and incorporated herein by reference, may be used.

As an option (not shown), if the video sensor is in motion (e.g. a video camera that pans, tilts, zooms, or translates), an additional block can be inserted in block 41 to provide background segmentation. Change detection can be accomplished by building a background model from the moving image, and motion detection can be accomplished by factoring out the camera motion to get the target motion. In both cases, motion compensation algorithms provide the necessary information to determine the background. A video stabilization that delivers affine or projective motion image alignment, such as the one described in U.S. patent application Ser. No. 09/606,919, filed Jul. 3, 2000, which is incorporated herein by reference, can be used to obtain video stabilization.

Further details of an exemplary process for performing background segmentation may be found, for example, in commonly-assigned U.S. patent application Ser. No. 09/815,385, filed Mar. 23, 2001, and incorporated herein by reference in its entirety.

Change detection module 41 is followed by a “blobizer” 42. Blobizer 42 forms foreground pixels into coherent blobs corresponding to possible targets. Any technique for generating blobs can be used for this block. An exemplary technique for generating blobs from motion detection and change detection uses a connected components scheme. For example, the morphology and connected components algorithm described in Lipton, Fujiyoshi, and Patil can be used.

The results from blobizer 42 are fed to target tracker 43. Target tracker 43 determines when blobs merge or split to form possible targets. Target tracker 43 further filters and predicts target location(s). Any technique for tracking blobs can be used for this block. Examples of such techniques include Kalman filtering, the CONDENSATION algorithm, a multi-hypothesis Kalman tracker (e.g., as described in W. E. L. Grimson et al., “Using Adaptive Tracking to Classify and Monitor Activities in a Site”, CVPR, 1998, pp. 22-29, and the frame-to-frame tracking technique described in U.S. patent application Ser. No. 09/694,712, referenced above. As an example, if the location is a casino floor, objects that can be tracked may include moving people, dealers, chips, cards, and vending carts.

As an option, blocks 41-43 can be replaced with any detection and tracking scheme, as is known to those of ordinary skill. One example of such a detection and tracking scheme is described in M. Rossi and A. Bozzoli, “Tracking and Counting Moving People,” ICIP, 1994, pp. 212-216.

As an option, block 43 may also calculate a 3D position for each target. In order to calculate this position, the camera may have any of several levels of information. At a minimal level, the camera knows three pieces of information—the downward angle (i.e., of the camera with respect to the horizontal axis at the height of the camera), the height of the camera above the floor, and the focal length. At a more advanced level, the camera has a full projection matrix relating the camera location to a general coordinate system. All levels in between suffice to calculate the 3D position. The method to calculate the 3D position, for example, in the case of a human or animal target, traces a ray outward from the camera center through the image pixel location of the bottom of the target's feet. Since the camera knows where the floor is, the 3D location is where this ray intersects the 3D floor. Any of many commonly available calibration methods can be used to obtain the necessary information. Note that with the 3D position data, derivative estimates are possible, such as velocity, acceleration, and also, more advanced estimates such as the target's 3D size.

A classifier 44 then determines the type of target being tracked. A target may be, for example, a human, a vehicle, an animal, or some other object. Classification can be performed by a number of techniques, and examples of such techniques include using a neural network classifier and using a linear discriminant classifier, both of which techniques are described, for example, in Collins, Lipton, Kanade, Fujiyoshi, Duggins, Tsin, Tolliver, Enomoto, and Hasegawa, “A System for Video Surveillance and Monitoring: VSAM Final Report,” Technical Report CMU-RI-TR-00-12, Robotics Institute, Carnegie-Mellon University, May 2000.

Finally, a primitive generation module 45 receives the information from the preceding modules and provides summary statistical information. These primitives include all information that the downstream inference module 23 might need. For example, the size, position, velocity, color, and texture of the target may be encapsulated in the primitives. Further details of an exemplary process for primitive generation may be found in commonly-assigned U.S. patent application Ser. No. 09/987,707, filed Nov. 15, 2001, and incorporated herein by reference in its entirety.

Vision module 22 is followed by an inference module 23. Inference module 23 receives and further processes the summary statistical information from primitive generation module 45 of vision module 22. In particular, inference module 23 may, among other things, determine when a target has engaged in a prohibited (or otherwise specified) activity (for example, when a person enters a restricted area).

In addition, the inference module 23 may also include a conflict resolution algorithm, which may include a scheduling algorithm, where, if there are multiple targets in view, the module chooses which target will be tracked by a slave 12. If a scheduling algorithm is present as part of the conflict resolution algorithm, it determines an order in which various targets are tracked (e.g., a first target may be tracked until it is out of range; then, a second target is tracked; etc.).

Finally, a response model 24 implements the appropriate course of action in response to detection of a target engaging in a prohibited or otherwise specified activity. Such course of action may include sending e-mail or other electronic-messaging alerts, audio and/or visual alarms or alerts, and sending position data to a slave 12 for tracking the target.

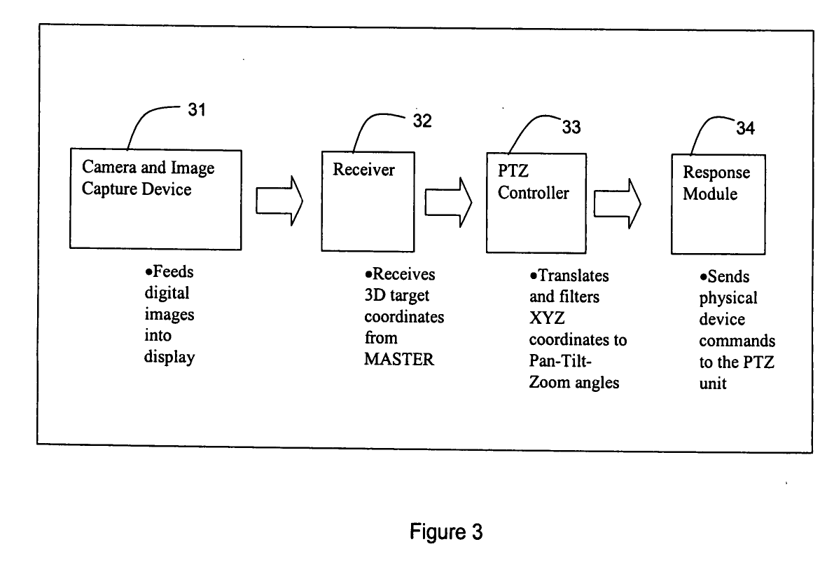

In the first embodiment, slave 12 performs two primary functions: providing video and controlling a robotic platform to which the slave's sensing device is coupled. FIG. 3 depicts information flow in a slave 12, according to the first embodiment.

As discussed above, a slave 12 includes a sensing device, depicted in FIG. 3 as “Camera and Image Capture Device” 31. The images obtained by device 31 may be displayed (as indicated in FIG. 3) and/or stored in memory (e.g., for later review). A receiver 32 receives position data from master 11. The position data is furnished to a PTZ controller unit 33. PTZ controller unit 33 processes the 3D position data, transforming it into pan-tilt-zoom (PTZ) angles that would put the target in the slave's field of view. In addition to deciding the pan-tilt-zoom settings, the PTZ controller also decides the relevant velocity of the motorized PTZ unit. The velocity is necessary to remove the jerkiness from moving the PTZ unit more quickly than the target. Smoothing algorithms are also used for the position control to remove the apparent image jerkiness. Any control algorithm can be used. An exemplary technique uses a Kalman filter with a feed-forward term to compensate for the lag induced by averaging. Finally, a response module 34 sends commands to a PTZ unit (not shown) to which device 31 is coupled. In particular, the commands instruct the PTZ unit so as to train device 31 on a target.

The first embodiment may be further enhanced by including multiple slave units 12. In this sub-embodiment, inference module 23 and response module 24 of master 11 determine how the multiple slave units 12 should coordinate. When there is a single target, the system may only use one slave to obtain a higher-resolution image. The other slaves may be left alone as stationary cameras to perform their normal duty covering other areas, or a few of the other slaves may be trained on the target to obtain multiple views. The master may incorporate knowledge of the slaves' positions and the target's trajectory to determine which slave will provide the optimal shot. For instance, if the target trajectory is towards a particular slave, that slave may provide the optimal frontal view of the target. When there are multiple targets to be tracked, the inference module 23 provides associated data to each of the multiple slave units 12. Again, the master chooses which slave pursues which target based on an estimate of which slave would provide the optimal view of a target. In this fashion, the master can dynamically command various slaves into and out of action, and may even change which slave is following which target at any given time.

When there is only one PTZ camera and several master cameras desire to gain higher resolution, the issue of sharing the slave arises. The PTZ controller 33 in the slave 12 decides which master to follow. There are many possible conflict-resolution algorithms to decide which master gets to command the slave. To accommodate, the slave puts all master commands on a queue. One method uses a ‘first come first serve’ approach and allows each master to finish before moving to the next. A second algorithm allocates a predetermined amount of time for each master. For example, after 10 seconds, the slave will move down the list of masters to the next on the list. Another method trusts a master to provide an importance rating, so that the slave can determine when to allow one master to have priority over another and follow that master's orders. It is inherently risky for the slave to trust the masters' estimates, since a malicious master may consistently rate its output as important and drown out all other masters' commands. However, in most cases the system will be built by a single manufacturer, and the idea of trusting a master's self-rated importance will be tolerable. Of course, if the slave were to accept signals from foreign manufacturers, this trust may not be warranted, and the slave might build up a behavioral history of each master and determine its own trust characteristics. For instance, particularly garrulous masters might indicate that a particular master sensor has a high false alarm rate. The slave might also use human input about each master to determine the level to which it can trust each master. In all cases, the slave would not want to switch too quickly between targets—it would not generate any useful sensory information for later consumption.

What happens while the slave is not being commanded to follow a target? In an exemplary implementation, the slave uses the same visual pathway as that of the master to determine threatening behavior according to predefined rules. When commanded to become a slave, the slave drops all visual processing and blindly follows the master's commands. Upon cessation of the master's commands, the slave resets to a home position and resumes looking for unusual activities.

### Active Slave Embodiment

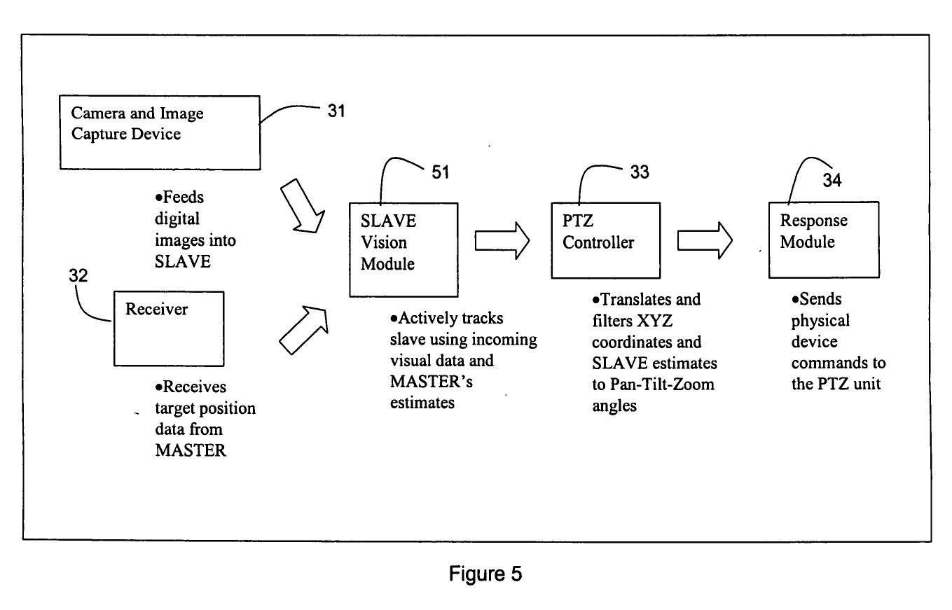

A second embodiment of the invention builds upon the first embodiment by making the slave 12 more active. Instead of merely receiving the data, the slave 12 actively tracks the target on its own. This allows the slave 12 to track a target outside of the master's field of view and also frees up the master's processor to perform other tasks. The basic system of the second embodiment is the same, but instead of merely receiving a steady stream of position data, the slave 12 now has a vision system. Details of the slave unit 12 according to the second embodiment are shown in FIG. 5.

As shown in FIG. 5, slave unit 12, according to the second embodiment, still comprises sensing device 31, receiver 32, PTZ controller unit 33, and response module 34. However, in this embodiment, sensing device 31 and receiver 32 feed their outputs into slave vision module 51, which performs many functions similar to those of the master vision module 22 (see FIG. 2).

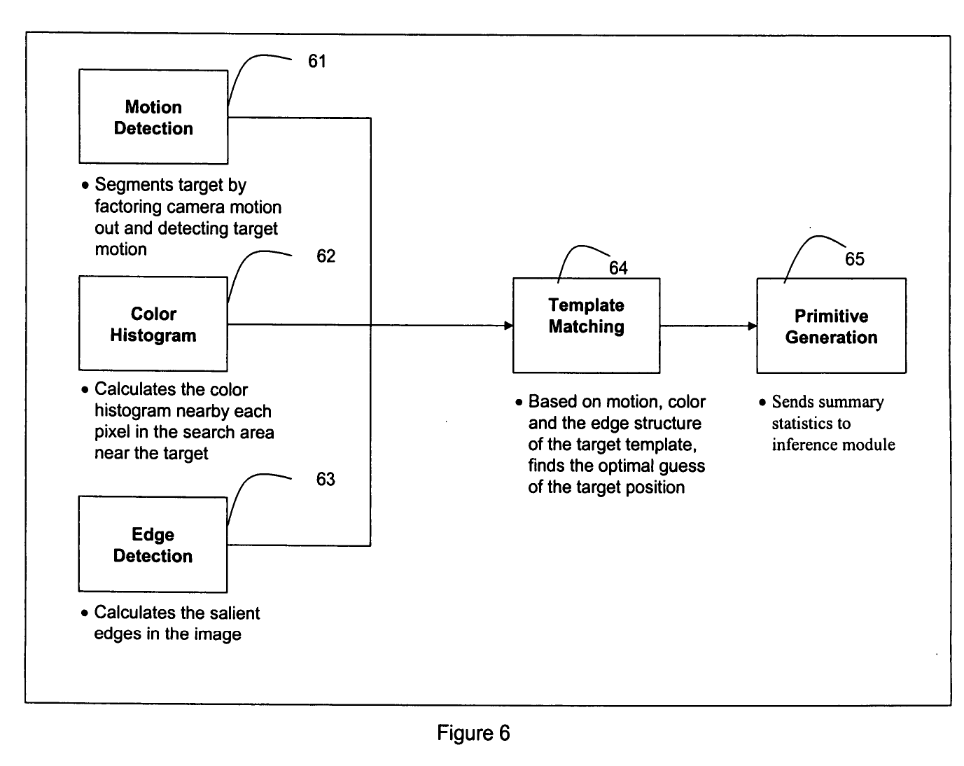

FIG. 6 depicts operation of vision module 51 while the slave is actively tracking. In this mode, vision module 51 uses a combination of several visual cues to determine target location, including color, target motion, and edge structure. Note that although the methods used for visual tracking in the vision module of the first mode can be used, it may be advantageous to use a more customized algorithm to increase accuracy, as described below. The algorithm below describes target tracking without explicitly depending on blob formation. Instead, it uses an alternate paradigm involving template matching.

The first cue, target motion, is detected in module 61. The module separates motion of the sensing device 31 from other motion in the image. The assumption is that the target of interest is the primary other motion in the image, aside from camera motion. Any camera motion estimation scheme may be used for this purpose, such as the standard method described, for example, in R. I. Hartley and A. Zisserman, Multiple View Geometry in Computer Vision, Cambridge University Press, 2000.

The motion detection module 61 and color histogram module 62 operate in parallel and can be performed in any order or concurrently. Color histogram module 62 is used to succinctly describe the colors of areas near each pixel. Any histogram that can be used for matching will suffice, and any color space will suffice. An exemplary technique uses the hue-saturation-value (HSV) color space, and builds a one dimensional histogram of all hue values where the saturation is over a certain threshold. Pixel values under that threshold are histogrammed separately. The saturation histogram is appended to the hue histogram. Note that to save computational resources, a particular implementation does not have to build a histogram near every pixel, but may delay this step until later in the tracking process, and only build histograms for those neighborhoods for which it is necessary.

Edge detection module 63 searches for edges in the intensity image. Any technique for detecting edges can be used for this block. As an example, one may use the Laplacian of Gaussian (LoG) Edge Detector described, for example, in D. Marr, Vision, W.H. Freeman and Co., 1982, which balances speed and accuracy (note that, according to Marr, there is also evidence to suggest that the LoG detector is the one used by the human visual cortex).

The template matching module 64 uses the motion data 61, the edge data 62, and the color data 63 from previous modules. Based on this information, it determines a best guess at the position of the target. Any method can be used to combine these three visual cues. For example, one may use a template matching approach, customized for the data. One such algorithm calculates three values for each patch of pixels in the neighborhood of the expected match, where the expected match is the current location adjusted for image motion and may include a velocity estimate. The first value is the edge correlation, where correlation indicates normalized cross-correlation between image patches in a previous image and the current image. The second value is the sum of the motion mask, determined by motion detection 61, and the edge mask, determined by edge detection 63, normalized by the number of edge pixels. The third value is the color histogram match, where the match score is the sum of the minimum between each of the two histograms' bins (as described above).

$$Match = {\sum }_{i ∈ Bins} Min ( Hist {1}_{i} , Hist {2}_{i} )$$

To combine these three scores, the method takes a weighted average of the first two, the edge correlation and the edge/motion summation, to form an image match score. If this score corresponds to a location that has a histogram match score above a certain threshold and also has an image match score above all previous scores, the match is accepted as the current maximum. The template search exhaustively searches all pixels in the neighborhood of the expected match. If confidence scores about the motion estimation scheme indicate that the motion estimation has failed, the edge summation score becomes the sole image match score. Likewise, if the images do not have any color information, then the color histogram is ignored.

In an exemplary embodiment, once the target has been found, the current image is stored as the old image, and the system waits for a new image to come in. In this sense, this tracking system has a memory of one image. A system that has a deeper memory and involves older images in the tracking estimate could also be used.

To save time, the process may proceed in two stages using a coarse-to-fine approach. In the first pass, the process searches for a match within a large area in the coarse (half-sized) image. In the second pass, the process refines this match by searching within a small area in the full-sized image. Thus, much computational time has been saved.

The advantages of such an approach are several. First, it is robust to size and angle changes in the target. Whereas typical template approaches are highly sensitive to target rotation and growth, the method's reliance on motion alleviates much of this sensitivity. Second, the motion estimation allows the edge correlation scheme to avoid “sticking” to the background edge structure, a common drawback encountered in edge correlation approaches. Third, the method avoids a major disadvantage of pure motion estimation schemes in that it does not simply track any motion in the image, but attempts to remain “locked onto” the structure of the initial template, sacrificing this structure only when the structure disappears (in the case of template rotation and scaling). Finally, the color histogram scheme helps eliminate many spurious matches. Color is not a primary matching criterion because target color is usually not distinctive enough to accurately locate the new target location in real-world lighting conditions.

A natural question that arises is how to initialize the vision module 51 of the slave 12. Since the master and slave cameras have different orientation angles, different zoom levels, and different lighting conditions, it is difficult to communicate a description of the target under scrutiny from the master to the slave. Calibration information ensures that the slave is pointed at the target. However, the slave still has to distinguish the target from similarly colored background pieces and from moving objects in the background. Vision module 51 uses motion to determine which target the master is talking about. Since the slave can passively follow the target during an initialization phase, the slave vision module 51 can segment out salient blobs of motion in the image. The method to detect motion is identical to that of motion detection module 61, described above. The blobizer 42 from the master's vision module 22 can be used to aggregate motion pixels. From there, a salient blob is a blob that has stayed in the field of view for a given period of time. Once a salient target is in the slave's view, the slave begins actively tracking it using the standard active tracking method described in FIG. 6.

Using the tracking results of slave vision module 51, PTZ controller unit 33 is able to calculate control information for the PTZ unit of slave 12, to maintain the target in the center of the field of view of sensing device 31. That is, the PTZ controller unit integrates any incoming position data from the master 11 with its current position information from slave vision module 51 to determine an optimal estimate of the target's position, and it uses this estimate to control the PTZ unit. Any method to estimate the position of the target will do. An exemplary method determines confidence estimates for the master's estimate of the target based on variance of the position estimates as well as timing information about the estimates (too few means the communications channel might be blocked). Likewise, the slave estimates confidence about its own target position estimate. The confidence criteria could include number of pixels in the motion mask (too many indicates the motion estimate is off), the degree of color histogram separation, the actual matching score of the template, and various others known to those familiar with the art. The two confidence scores then dictate weights to use in a weighted average of the master's and slave's estimate of the target's position.

Best Shot

In an enhanced embodiment, the system may be used to obtain a “best shot” of the target. A best shot is the optimal, or highest quality, frame in a video sequence of a target for recognition purposes, by human or machine. The best shot may be different for different targets, including human faces and vehicles. The idea is not necessarily to recognize the target, but to at least calculate those features that would make recognition easier. Any technique to predict those features can be used.

In this embodiment, the master 11 chooses a best shot. In the case of a human target, the master will choose based on the target's percentage of skin-tone pixels in the head area, the target's trajectory (walking towards the camera is good), and size of the overall blob. In the case of a vehicular target, the master will choose a best shot based on the size of the overall blob and the target's trajectory. In this case, for example, heading away from the camera may give superior recognition of make and model information as well as license plate information. A weighted average of the various criteria will ultimately determine a single number used to estimate the quality of the image. The result of the best shot is that the master's inference engine 23 orders any slave 12 tracking the target to snap a picture or obtain a short video clip. At the time a target becomes interesting (loiters, steals something, crosses a tripwire etc.), the master will make such a request. Also, at the time an interesting target exits the field of view, the master will make another such request. The master's 11 response engine 24 would collect all resulting pictures and deliver the pictures or short video clips for later review by a human watchstander or human identification algorithm.

In an alternate embodiment of the invention, a best shot of the target is, once again, the goal. Again, the system of the first embodiment or the second embodiment may be employed. In this case, however, the slave's 12 vision system 51 is provided with the ability to choose a best shot of the target. In the case of a human target, the slave 12 estimates shot quality based on skin-tone pixels in the head area, downward trajectory of the pan-tilt unit (indicating trajectory towards the camera), the size of the blob (in the case of the second embodiment), and also stillness of the PTZ head (the less the motion, the greater the clarity). For vehicular targets, the slave estimates shot quality based on the size of the blob, upward pan-tilt trajectory, and stillness of the PTZ head. In this embodiment, the slave 12 sends back the results of the best shot, either a single image or a short video, to the master 11 for reporting through the master's response engine 24.

Master/Master Handoff

In a further embodiment of the invention, multiple systems may be interfaced with each other to provide broader spatial coverage and/or cooperative tracking of targets. In this embodiment, each system is considered to be a peer of each other system. As such, each unit includes a PTZ unit for positioning the sensing device. Such a system may operate, for example, as follows.

Considering a system consisting of two PTZ systems (to be referred to as “A” and “B”), initially, both would be master systems, waiting for an offending target. Upon detection, the detecting unit (say, A) would then assume the role of a master unit and would order the other unit (B) to become a slave. When B loses sight of the target because of B's limited field of view/range of motion, B could order A to become a slave. At this point, B gives A B's last known location of the target. Assuming A can obtain a better view of the target, A may carry on B's task and keep following the target. In this way, the duration of tracking can continue as long as the target is in view for either PTZ unit. All best shot functionality (i.e., as in the embodiments described above) may be incorporated into both sensors.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A method, comprising:
obtaining image information about a scene, the image information comprising an image sequence including a plurality of images of the scene;
processing the image information to detect an object in the scene;
processing the object to determine if the object is a target;
locating the target in the images in the image sequence;
determining a classification for the target based on the image information;
generating statistics about each image in the image sequence based on an appearance of the target in that respective image and the classification of the target;
determining at least one image in the image sequence that indicates identifying information for the target based on the classification of the target and the statistics to obtain a best shot image; and
storing the best shot image.

2. The method of claim 1, wherein the classification is one of human, animal, vehicle or default.

3. The method of claim 2, wherein generating statistics comprises measuring at least one of skin tone pixels of the target, a trajectory of the target or a size of the target when the classification of the target is human.

4. The method of claim 2, wherein the identifying information includes a face when the classification of the target is human.

5. The method of claim 2, wherein generating statistics comprises measuring at least one of a trajectory of the target or a size of the target when the classification of the target is vehicle.

6. The method of claim 2, wherein the identifying information includes a license plate when the classification of the target is vehicle.

7. The method of claim 2, wherein the identifying information includes make or model information when the target classification is vehicle.

8. The method of claim 3, wherein determining the best shot image comprises selecting the image including the most skin tone pixels.

9. The method of claim 3, wherein determining the best shot image comprises selecting the image having a trajectory towards the sensing device.

10. The method of claim 6, wherein determining further comprises selecting the image including the license plate information as the best shot image.

11. The method of claim 4, wherein determining further comprises selecting the image including the face as the best shot image.

12. The method of claim 7, wherein determining further comprises selecting the image including the make or model information as the best shot image.

13. The method of claim 1, further comprising:
determining when the target violates a predetermined condition; and
determining the best shot image of the target when the target violates the predetermined condition.

14. The method of claim 1, wherein locating the target comprises performing a template matching process.

15. The method of claim 1, wherein locating the target further comprises performing a frame differencing process.

16. The method of claim 1, further comprising performing with a plurality of slave sensing units and providing respective best shot images of the slave sensing units to a master sensing unit over a communication medium that connects the master sensing unit to the slave sensing units;
determining with the master sensing unit which of the best shot images from the slave sensing units is optimal; and
directing the slave sensing unit with the optimal best shot image to follow the target.

17. The method of claim 1, wherein a master sensing unit is connected over a communication medium to a plurality of slave sensing units and further comprising:
determining with the master sensing unit which of the slave sensing units may provide the best shot image to obtain a selected slave sensing unit; and
directing the selected slave sensing unit to follow the target to obtain the best shot image, wherein the selected slave sensing unit performs the method of claim 1 to obtain the best shot image.

18. The method of claim 16, wherein directing the slave sensing unit comprises providing position information about the target from the master sensing unit to the slave sensing unit.

19. The method of claim 16, wherein directing the slave sensing unit comprises providing the images from the image sequence of the master sensing unit to the slave sensing unit.

20. The method of claim 16, further comprising following the target with the slave sensing unit based on instructions from the master sensing unit.

21. The method of claim 16, further comprising following the target with the slave sensing unit independent of instructions from the master sensing unit.

22. The method of claim 16, further comprising following the target with the slave sensing unit based on 1) instructions from the master sensing unit and 2) instructions generated with the slave sensing unit.

23. The method of claim 16, further comprising:
generating visual cues from the images using the slave sensing unit;
locating the target in a field of view with the slave based on the visual cues;
moving the slave sensing unit to track the target.

24. The method of claim 23, wherein the visual cues include at least one of target motion, color, or edge detection.

25. The method of claim 23, wherein locating the target comprises using template matching.

26. The method of claim 23, wherein moving the slave comprises changing a position, orientation, zoom or focus of the slave.

27. The method of claim 1, further comprising a plurality of masters.

28. A video sensing system, comprising:
a sensor device obtaining image information about a scene, the image information comprising an image sequence including a plurality of images of the scene;
a segmentation module processing the image information and detecting an object in the scene;
a target tracker module processing the object to determine if the object is a target;
a classification module determining a classification for the target based on the image information; and
a vision module generating statistics about each image in the image sequence based on an appearance of the target in that respective image and the classification of the target and determining at least one image in the image sequence that indicates identifying information for the target based on the classification of the target and the statistics to obtain a best shot image.

29. The system of claim 28, wherein the video sensing system is a slave sensing unit and further comprising a plurality of slave sensing units coupled to a master sensing unit via a communication medium, the slave sensing unit providing their best shot images to the master sensing unit over the communication medium, the master sensing unit including a best shot identification module determining which of the best shot images from the slave sensing units is optimal and a response module directing the slave sensing unit with the optimal best shot image to follow the target.

30. The system of claim 29, wherein the classification is one of human, animal, vehicle or default.

31. The system of claim 30, wherein the statistics include at least one of skin tone pixels of the target, a trajectory of the target or a size of the target when the classification of the target is human.

32. The system of claim 30, wherein the vision module locates a target image region a face based on the statistics when the classification of the target is human

33. The system of claim 30, wherein the statistics include at least one of a trajectory of the target or a size of the target when the classification of the target is vehicle.

34. The system of claim 30, wherein the vision module locates a target image region including a license plate based on the statistics when the classification of the target is vehicle.

35. The system of claim 30, wherein the vision module locates a target image region including make or model information based on the statistics when the target classification is vehicle.

36. The system of claim 31, wherein the best image identification module selects the image including the most skin tone pixels as the best shot image.

37. The system of claim 33, wherein the best image identification module selects the image having a trajectory towards the sensing device as the best shot image.

38. The system of claim 28, further comprising:
an inference module determining when the target violates a predetermined condition, wherein the vision module determines the best shot image when the target violates the predetermined condition.

39. The system of claim 28, wherein the video sensing system comprises a slave sensing unit and the vision module of the slave sensing unit generates visual cues from the images; locates the target in a field of view of the slave based on the visual cues; and further comprises a response module that directs movement of the slave sensing unit to track the target.

40. The system of claim 28, wherein the vision sensing system further comprises a master sensing unit and a slave sensing unit connected by a communication medium, the master sensing unit providing the images to the slave sensing unit via the communication medium, the slave sensing unit including a slave vision module to generate visual cues from the images from the master sensing unit; locate the target in a field of view of the slave based on the visual cues and a response module that directs movement of the slave sensing unit to track the target.

41. The system of claim 39, wherein the visual cues include at least one of target motion, color, or edge detection.

42. The system of claim 39, wherein the vision module locates the target using template matching

43. The system of claim 39, wherein the response module directs movement of the slave sensing unit by changing a position, orientation, zoom or focus.

44. The system of claim 28, further comprising a plurality of masters.

45. The system of claim 28, further comprising a plurality of slaves.
